(19) United States
(12) Patent Application Publication
(10) Pub. No.: US 2009/0116838 A1
(43) Pub. Date: May 7, 2009

(54) Bi-directional optical module with a polarization independent optical isolator

(75) Inventor: Toshiaki Kihara, Kanagawa (JP)

Correspondence Address: VENABLE LLP, P.O. BOX 34385, WASHINGTON, DC, 20043-9998, US

(73) Assignee: Sumitomo Electric Industries, Ltd., Osaka (JP)

(21) Appl. No.: 11/905,505

(22) Filed: Oct. 1, 2007

(30) Foreign Application Priority Data
Oct. 3, 2006 (JP) 2006-271354

(51) Int. Cl. H04J 14/02

(52) U.S. Cl. 398/79

(57) ABSTRACT

The present invention provides a bi-directional optical module with an optical isolator to prevent stray light from entering the laser diode (LD). The module includes a distributed feedback LD (DFB-LD), a photodiode (PD), a wavelength division multiplexed (WDM) filter, and a polarization independent isolator placed between the WDM filter and the optical fiber. The stray light emitted from the LD and scattered by optically discontinuous interface is prevented from returning to the LD by the isolator. Although the isolator shifts the optical axis of the receiving optical signal emitted from the optical fiber, the PD with a wide optical sensitive surface may receive almost whole portion of the receiving optical signal.

### BACKGROUND OF THE INVENTION

1. Field of the Invention

The present invention relates to an optical module, in particular, the invention relates to a bi-directional optical sub-assembly that installs with a polarization independent optical isolator.

2. Related Prior Art

Some optical communication system adopt the PON (Passive Optical Network) system for the subscriber network to realize a high speed and a large capacity communication in relatively low cost. This PON system not only cuts a number of fibers to be used by applying a bi-direction module, but a plurality of subscribers commonly owns the single fiber, which enables the high speed and the low cost service comparable to the system using the conventional metal cables. The PON system also adopts the WDM (wavelength division multiplexing) communication where the optical signals with wavelengths of 1.31 μm and 1.55 μm (and/or 1.49 μm) are transmitted or received in the single fiber.

The bi-direction optical module applied in such PON system has an arrangement that the transmitting light emitted from a laser diode (hereafter denoted as LD) may be optically coupled with the optical fiber, while, the receiving light emitted from the fiber to a photodiode (hereafter denoted as PD). Various arrangements of the LD, the PD, and other optical components for such bi-directional optical module have been presented.

One example of such bi-directional module is, what is called, a two-package bi-directional module, where the module installs a transmitted optical sub-assembly (hereafter denoted as TOSA) and a receiver optical sub-assembly (hereafter denoted as ROSA) with packages independent to each other, and a wavelength division multiplexed filter (hereafter denoted as WDM filter) between the TOSA and the ROSA. The transmitting light emitted from the LD within the TOSA couples with the fiber after passing the WDM filter, while, the receiving light emitted from the fiber couples with the PD after the reflection by the WDM filter. Such bi-directional module with two packages has an inherent week point to raise the production cost.

A bi-directional module with single package, which is common to the TOSA and the ROSA, installs all devices or components, such as an LD, a PD, a lens, a mirror, a WDM filter and others, for the optical communication within one package. The United States Patent Application, US 2006-269197A, has disclosed one type of such bi-directional module, in which the light emitted from the LD couples with the optical fiber reflected by the WDM filter and concentrated by the lens, while the light emitted from the fiber couples with the PD condensed by the lens and passing through the WDM filter.

The LD typically applied in the bi-directional module is a type of a distributed feedback laser diode (hereafter denoted as DFB-LD) that integrates a diffraction grating to sharpen the optical spectrum of the light emitted therefrom within the body of the LD. While, in spite of its sharpened output optical spectrum, the DFB-LD has an inferior tolerance to the optical noise. That is, when the stray light, which is emitted from the LD and scattered or reflected at the end face of the optical fiber or at the other optically discontinuous interface, enters the cavity of the LD again, it makes the oscillation of the LD in stable to widen the width of the output spectrum.

Accordingly, the DFB-LD is necessary to provide an optical means between the LD and the optical fiber to prevent the stray light from entering the body of the LD. A typical device to show such function is an optical isolator, which passes the forward light advancing from the LD to the optical fiber and prevents the backward light returning from the fiber to the LD. Japanese Patent Applications, published as JP-2004-170798A or JP2005-215219A, has disclosed an optical module built with an optical isolator therein.

Two types of optical isolators are well known, one of which is the polarization dependent isolator, while, the other is the polarization independent isolator. FIG. 6A schematically illustrates a mechanism of the polarization independent isolator where the forward light mass pass the isolator, while, FIG. 6B schematically illustrates the mechanism where the backward light is prevented from passing through the isolator. The polarization independent isolator generally includes two birefringent plates, 62a and 62b, that sandwiches the Faraday rotator 61 there between. The crystal axis of the birefringent plates, 62a or 62b, is shown by the arrow “D”.

The forward light has two polarizations, Er and Or, one of which is parallel to the z-direction, while the other of which is parallel to the y-direction, respectively. The former polarization is called as the extraordinary ray, while the latter is called as the ordinary ray. When such forward light enters the first birefringent plate 62a, this birefringent plate 62a divided it into two rays and shifts only the extraordinary ray Er by a separation along to the z-direction at the output surface 72a. The separation depends on the birefringent characteristic of the crystal 62a and the thickness of the plate.

The Faraday rotator 61 rotates the polarization of both rays, Er and Or, by −45° at the exit surface 71 thereof. Further, the other birefringent plate 62a shifts only the extraordinary ray Er at the exit surface 72b, while, it keeps the optical axis of the ordinary ray. Accordingly, the ordinary ray may optically couple with the optical fiber. The extraordinary ray does not optically couple with the fiber and it becomes the stray light, denoted as P, because its axis is sifted by the two birefringent plates, 62a and 62b.

For the backward light, which has also two polarizations, Er and Or, one of which Er is in parallel to the crystal axis D of the birefringent plate 62b, while the other of which Or is in perpendicular to the crystal axis at the entrance surface 70, as shown in FIG. 6B. The birefringent plate 62b divides these into two rays, Er and Or, and shifts only the optical axis of the extraordinary ray Er at the exit surface 72b thereof.

The Faraday rotator rotates the polarization of both rays, Er and Or, by −45° at the exit surface 71 thereof, which converts the ordinary ray Or at the entrance surface 70 of the first birefringent plate 62b into the extraordinary ray Er at the exit surface 71 of the Faraday rotator 61. Then, the other birefringent plate 62a shifts the axis of the extraordinary ray Er, which is originally the ordinary ray Or as explained above, to the direction determined by the crystal axis of the birefringent plate 62a. Thus, the polarization independent isolator shifts the optical axis of the backward light in both polarizations thereof, which is denoted by circle Q in FIG. 6B.

### SUMMARY OF THE INVENTION

One aspect of the present invention relates to a bi-directional optical module. The module includes a semiconductor laser diode that emits transmitting light to an optical fiber, a photodiode that receives receiving light emitted from the optical fiber, which has a wavelength different to the transmitting light, a wavelength division multiplexed filter that reflects the transmitting light and transmits the receiving light, or transmits the transmitting light and reflects the receiving light, and an isolator placed between the wavelength division multiplexed filter and the optical fiber. The present optical module has features that the isolator is a type of the polarization independent isolator; the laser diode is positioned on the optical axis of the ordinary light of the isolator, while the photodiode is positioned on the optical axis of the extraordinary light of the isolator.

The optical module of the present invention may have an optical device with a co-axial package that is constituted of a stem where the laser diode and the photodiode are mounted and a cap attached to the stem, wherein the stem and the cap forms a cavity into which the laser diode and the photodiode are installed. The optical module may have a sleeve assembly and a joint sleeve. The sleeve assembly receives an external optical fiber to which the laser diode and the photodiode optically couple. The joint sleeve optically aligns the sleeve assembly to the optical device to optically couple the laser diode and the photodiode with the optical fiber. The optical module may install the isolator in the inner side of the joint sleeve and the cap of the optical device may provide a condenser lens in a ceiling thereof.

The polarization independent isolator of the present invention includes a pair of birefringent plates and a Faraday rotator put between the birefringent plates. In the optical module, two birefringent plates and the Faraday rotator have a slab shape with uniform thicknesses, respectively, and the optical axis of the isolator may be inclined to the optical axis of the optical fiber. In a modification, the optical isolator has a uniform thickness comprised of two birefringent plats with linearly varying thickness and the Faraday rotator with a uniform thickness. In this arrangement of the isolator, the normal of two surfaces of the isolator may be inclined to the optical axis of the optical fiber, or the normal of two surfaces of the isolator is in parallel to the optical axis of the fiber but the normal of two surfaces of the Faraday rotator may be inclined to the optical axis of the optical fiber.

### BRIEF DESCRIPTION OF DRAWINGS

FIG. 1 is a cross section of the package of the bi-directional optical module according to the present invention;

FIG. 2A schematically describes the process of the transmitting light emitted from the LD to optically couple to the optical fiber, and FIG. 2B schematically explains the mechanism of the polarization independent isolator for the transmitting light;

FIG. 3A schematically describes the process of the scattered backward light not to return to the LD, and FIG. 3B schematically explains the mechanism of the polarization independent isolator to shift the optical position of backward light;

FIG. 4 shows behaviors of the beam shift S of the scattered backward light with respect to the thickness of the polarization independent isolator T;

FIG. 5 schematically describes the process of the receiving light to optically couple with the PD; and

FIG. 6A explains the mechanism for the forward light to pass the polarization independent isolator, while FIG. 6B explains the mechanism for the backward light to prevent from passing through the isolator.

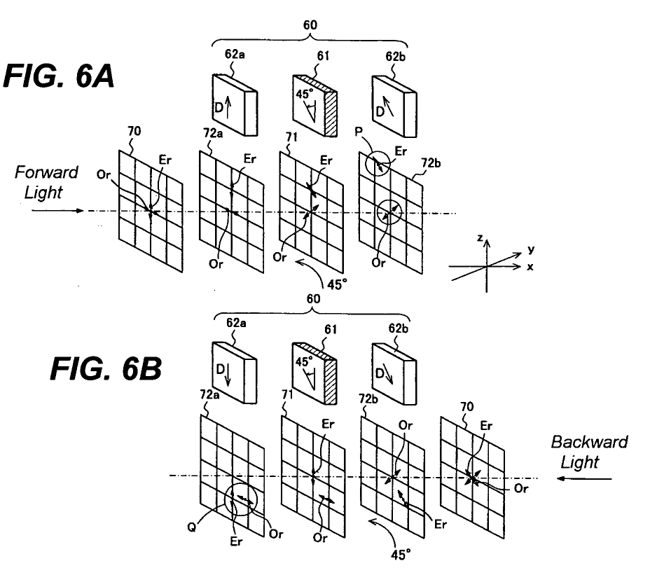

### DETAILED DESCRIPTION OF THE INVENTION

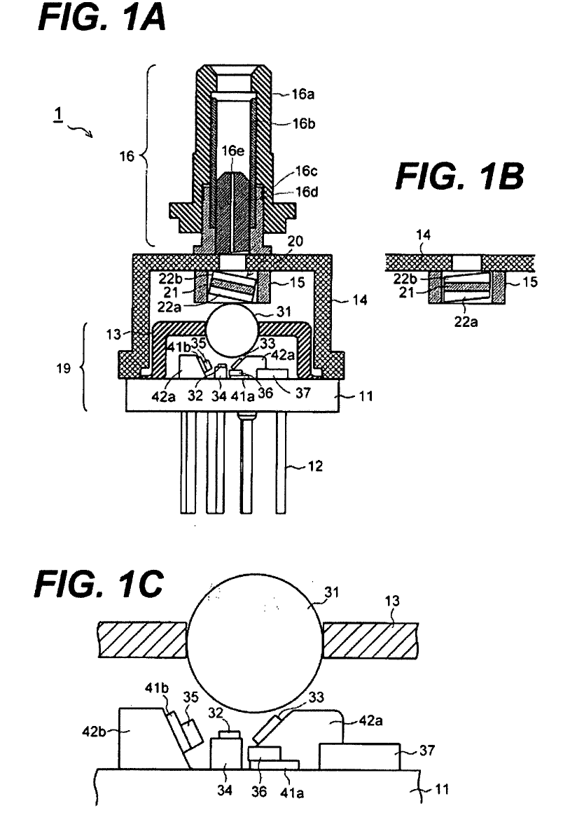

Next, one packaged bi-direction module (hereafter denoted as BiD module) with a polarization independent isolator will be described in detail. FIG. 1A is a cross section of the BiD module 1, FIG. 1B is a cross section of the polarization independent isolator, and FIG. 1C magnifies the primary portion of the BiD module 1. The BiD module 1 includes a disk shaped stem 11, a DFB-LD 32 and a PD 36. The DFB-LD 32 emits the transmitted light to the optical fiber that is not shown in FIG. 1A, while, the PD 36 receives the received light with a wavelength different from that of the transmitted light. These two optically active devices, the DFB-LD 32 and the PD 36, are mounted on the stem 11. That is, the DFB-LD 32 is mounted on an optical axis for the ordinary ray of the polarization independent isolator 20, while, the PD is mounted on the other axis for the extraordinary ray of the polarization independent isolator 20.

The stem 11 further provides a plurality of lead terminals 12 and a cap 13 accompanied with a lens 31. The stem 11 and the cap 13 form a space within which the DFB-LD 32, the PD 36 and other optical and electrical components are installed. The stem 11 and the cap 13 with the lens constitute an optical device 19 with a CAN-type package. The sleeve member 16, which includes various members such as a bush 16c, a stub 16d with a coupling fiber 16e in a center thereof, a sleeve 16b, and a sleeve cover 16a, and a joint sleeve 14 that mechanically couples the optical device 19 with the stem 11 and the cap 13 to the sleeve member 16 to optically couple the DFB-LD 32 and the PD 36 with the optical fiber in the stub 16d of the sleeve member 16. The sleeve member 16 together with the optical device 19 constitutes the BiD module with a co-axial shape.

One end of the joint sleeve 14 is fixed to the stem 11 such that the cylinder portion of the joint sleeve 14 wraps the side of the cap 13. The other end of the joint sleeve 14 mounts the sleeve member 16 thereon. The isolator 20 is attached to the inner surface of the joint sleeve 14, which is opposite to the end surface on which the sleeve member 16 is mounted, via the holder 15. The isolator 20 has a function to prevent the backward light returning to the DFB-LD 32. The backward light means the light advancing toward the LD 32, while, the forward light means the light emitted from the LD 32 to advance toward the sleeve member 16. The polarization independent isolator 20 provides a Faraday rotator 21 and a pair of birefringent plates, 22a and 22b.

These two birefringent plates, 22a and 22b, in FIG. 1A has a slab shape with a uniform thickness and put the Faraday rotator 21 there between, but the optical axis of the isolator 20, which is the normal of the slab shaped birefringent crystals, 22a and 22b, is inclined with respect to the optical axis connecting the coupling fiber 16e with the optical device 19. In an alteration, the birefringent plates, 22a and 22b, may have a wedge shape with a linearly increasing thickness but the total thickness of the isolator 20 is uniform, where the normal of the Faraday rotator is in parallel to the optical axis connecting the coupling fiber 16e and the optical device 19, while, the normal of the outer surface of the birefringent plates, 22a and 22b, is inclined to the optical axis.

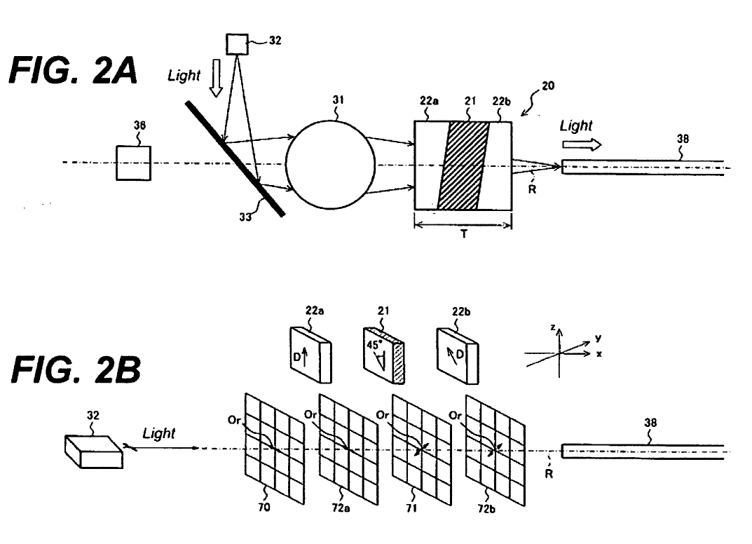

Still further modification of the isolator 20 may be applicable, where the birefringent plates, 22a and 22b, have the wedge shape but the normal of the outer surface thereof is in parallel to the optical axis, while the Faraday rotator has a constant thickness but the normal of the rotator is inclined to the optical axis. This modified arrangement of the isolator 20, which is illustrated in FIG. 2A, makes it possible to change the separation between the ordinary ray and the extraordinary ray of the isolator 20.

The condenser lens 31 may be a ball lens, which concentrates the transmitted light emitted from the DFB-LD 32 on the coupling fiber 16e and the received light emitted from the coupling fiber 16e on the PD 35. The DFB-LD shows a good chirping characteristic. The WDM filter 33 reflects the transmitted light from the LD 32 to the coupling fiber 16e and passes the received light emitted from the coupling fiber 16e to the PD 36. The sub-mount 34 mounts the DFB-LD 32 thereon, while, another sub-mount 41a mounts the PD 36. The optical device 19 may provide another PD 35 for monitoring a portion of the back light emitter from the back facet of the DFB-LD 32. The monitor PD 35 is mounted on the third sub-mount 41b.

The electronic circuit 37 controls the DFB-LD 32 and the PD 35. The first block with a slant surface supports the WDM filter 33 on this slant surface, while, the second block 42b with a slant surface mounts the assembly of the monitor PD 35 and the sub-mount 41b on this slant surface. Accordingly, the light-receiving surface of the monitor PD 35 is inclined to the optical axis of the DFB-LD 32. These first and second blocks, 42a and 42b, are built in the stem 11 of the optical device 19.

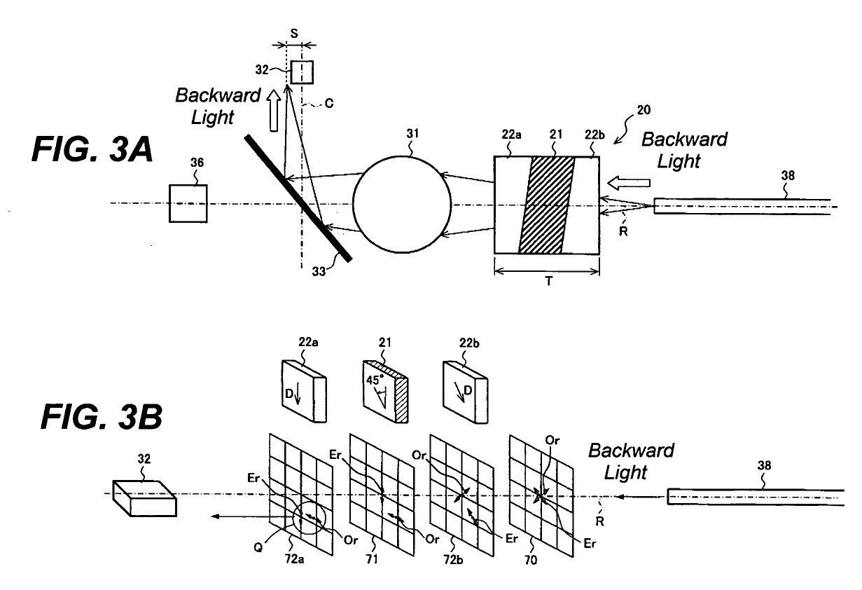

Next, two mechanisms of the polarization independent isolator 20 will be explained, one of which is that the transmitted light from the DFB-LD 32 may couple with the fiber 16e in FIG. 2, while the other of which is that the reflected light of the transmitted light or the received light, which is the backward light, may uncouple from the DFB-LD 32, which is shown in FIG. 3. As shown in FIGS. 2 and 3, the isolator has the arrangement that two birefringent plates have the wedge shape but the outer surface thereof is in parallel to the optical axis, while, the surface of the Faraday rotator which has the slab shape with an uniform thickness is inclined to the optical axis. This arrangement of the isolation 20 may change the separation between the ordinary ray and the extraordinary ray.

Although FIGS. 2B and 3B simply illustrate the birefringent plates, 22a and 22b, as the slab shape with the uniform thickness; they are practically the wedge shaped birefringent plate.

As shown in FIG. 2A, the transmitted light with a wavelength of 1310 nm is reflected at the WDM filter 33, concentrated by the lens 31 and finally passes the polarization independent isolator 20. The ordinary ray Or of the transmitted light passing through the isolator 20 rotates the polarization thereof by −45° and enters the fiber 16e. Thus, the transmitted light may pass the isolator with substantially no loss to couple with the fiber 38.

On the other hand, the backward light, which is a portion of the transmitted light reflected at the end of the fiber 38, passes the isolator 20. However, one of the birefringence crystal 22b shifts the axis of the extraordinary ray Er, and the Faraday rotator 21 rotates the polarization of both the ordinary ray Or and the extraordinary ray Er by −45°. Finally, the other birefringent plates 22a shifts the axis of the extraordinary ray to a location marked Q in FIG. 3B. Thus, the backward light may not enter the LD 32. In FIG. 3, the symbol S means the separation of the backward light at the facet of the LD 32, while the other symbol c denotes the center of the LD 32, which corresponds to the optical axis of the LD 32.

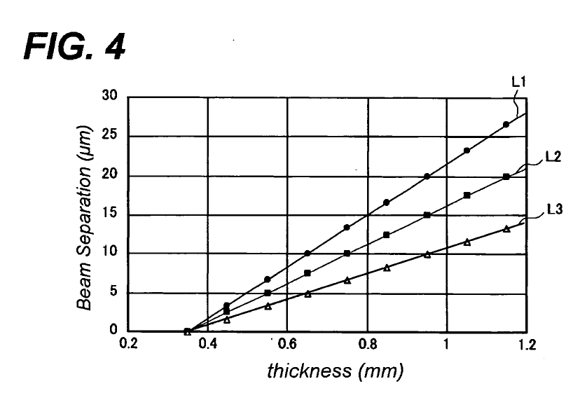

Next, the relation between the separation S and the thickness T of the isolator will be described as referring to FIG. 4. The behaviors L1 to L3 denote the separation of the beam S (μm) from the original position with respect to the thickness T (mm) of the isolator under conditions of the magnification factor of the image, 1.5, 2.0 and 3.0, respectively. The embodiments aforementioned, which has the magnification factor about 2.0 and the thickness of the isolation about 1 mm. In this case, the beam shift becomes about 20 μm, which is enough separation to prevent the backward beam from re-entering the DFB-LD 32, which prevents the DFB-LD 32 from being degraded in the oscillation performance thereof.

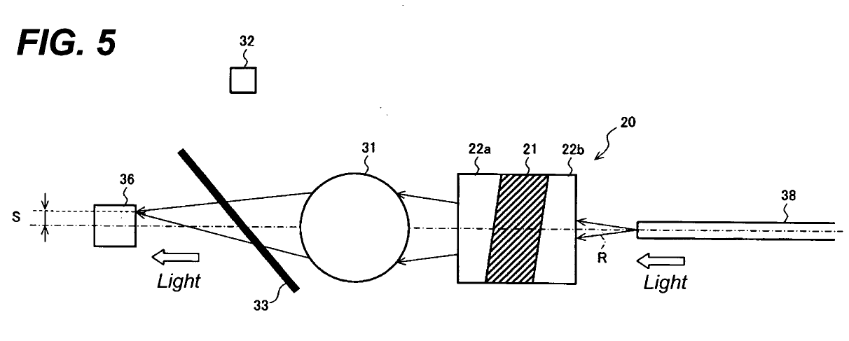

FIG. 5 illustrates a condition where the received light, which is the backward light, may optically couple with the PD as passing through the isolator. The received light emitted from the fiber 38 and has a wavelength of 1490 nm passes through the polarization independent isolator 20 and enters the PD 36. In this condition, the received light shifts its entering position to the PD 36 from the center R thereof by about 20 μm (S=20 μm), similar to the case for the scattered light of the transmitted light mentioned above. However, because the sensing area of the PD 36 has a diameter greater than 50 μm, typically 50 to 80 μm, the PD 36 may receive almost whole portion of the received light even if the light shifts the position thereof by the isolator 20.

Thus, according to the present arrangement of the bi-directional optical module, which installs the polarization independent isolator in addition to the DFB-LD and the PD, the scattered backward light does not re-enter in the DFB-LD and the received backward light with the wavelength different from the scattered backward light does enter the PD with substantially negligible optical loss. The scattered backward light may not enter the PD because the WDM filter installed in front of the PD reflects the substantially whole portion thereof.

Additional modifications and improvements of the present invention may also be apparent to those of ordinary skill in the art. Thus, the particular combination of parts described and illustrated herein is intended to represent only certain embodiments of the present invention, and is not intended to serve as limitations of alternative devices within the spirit and scope of the invention.

I claim:

1. A bi-directional optical module coupled with an external optical fiber, comprising:
a semiconductor laser diode to emit transmitting light with a first wavelength to the external optical fiber;
a photodiode to receive receiving light with a second wavelength emitted from the external optical fiber, the first wavelength being different from the second wavelength;
a wavelength division multiplexed filter configured to reflect the transmitting light and to transmit the receiving light, or configured to transmit the transmitting light and to reflect the receiving light; and
an optical isolator put between the optical fiber and the wavelength division multiplexed filter,
wherein the optical isolator is a polarization independent isolator.

2. The bi-directional optical module according to claim 1,
wherein the laser diode is positioned on a first optical axis for an ordinary ray of the optical isolator, and the photodiode is positioned on a second optical axis for an extraordinary ray of the optical isolator.

3. The bi-directional optical module according to claim 1,
further comprising a stem and a cap attached to the stem,
wherein the stem and the cap forms a co-axial package with a space to install the laser diode, the photodiode, and the wavelength division multiplexed filter therein.

4. The bi-directional optical module according to claim 3,
further comprising a sleeve assembly to receive the external fiber therein and a joint sleeve to optical align the sleeve assembly with the optical device,
wherein the isolator is installed within the joint sleeve.

5. The bi-directional optical module according to claim 1,
wherein the optical isolator comprises a pair of birefringent plates with a uniform thickness and a Faraday rotator with a uniform thickness, the Faraday rotator being put between the birefringent plates,
wherein two surfaces of the optical isolator each facing the optical fiber or the wavelength division multiplexed filter has the normal inclined to an optical axis of the external optical fiber.

6. The bi-directional optical module according to claim 1,
wherein the optical isolator comprises a pair of birefringent plates with a linearly varying thickness and a Faraday rotator with a uniform thickness, the Faraday rotator being put between the birefringent plates, and
wherein an external surface of one of the birefringent plates facing the optical fiber and an external surface of the other of birefringent plates facing the wavelength division multiplexed filter are in parallel to the optical axis of the external optical fiber, and the other surface

7. The bi-directional optical module according to claim 1,
wherein the optical isolator comprises a first birefringent plate, a second birefringent plate, and a Faraday rotator with a uniform thickness, the first and second birefringent plates having a linearly varying thickness, the Faraday rotator being put between the first and second birefringent plates, and
wherein an external surface of the first birefringent plates facing the optical fiber and an external surface of the second birefringent plates facing the wavelength division multiplexed filter are in parallel to the optical axis of the external optical fiber, and the inner surface of the first birefringent plate and the inner surface of the second birefringent plate each facing the Faraday rotator are inclined to the optical axis of the external fiber.

8. The bi-directional optical module according to claim 1,
wherein the laser diode is a distributed feedback laser diode.
